(19) United States
(12) Patent Application Publication
(10) Pub. No.: US 2005/0192422 A1
(43) Pub. Date: Sep. 1, 2005

(54) Use of a dianol 220/HER mixture as chain extender for polyurethane elastomer formulations

(76) Inventors: Georges Da Costa, Lagarrigue (FR); Daniel Muller, Saint Maur (FR); Herve Rolland, Castres (FR)

Correspondence Address: AIR LIQUIDE, 2700 POST OAK BOULEVARD, SUITE 1800, HOUSTON, TX, 77056, US

(21) Appl. No.: 10/888,397

(22) Filed: Jul. 9, 2004

(30) Foreign Application Priority Data
Jul. 11, 2003 (FR) 0350323

(51) Int. Cl. C08G 18/00; C08J 9/00

(52) U.S. Cl. 528/44; 528/196; 528/272; 528/87

(57) ABSTRACT

Composition, characterized in that it comprises:
from 0.5% to 100% by weight of a compound of formula (I): 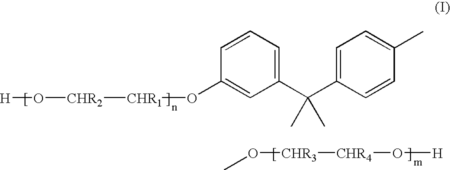
in which R₁, R₂, R₃ and R₄ represent a hydrogen atom, a methyl radical or an ethyl radical, n and m represent a number between 0 and 10, it being understood that the sum n+m is greater than zero, and
   from 0% to 99.5% by weight of a compound of formula (II): 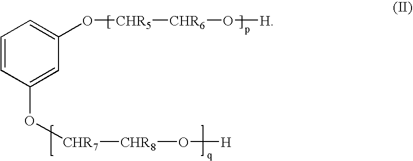
in which R₅, R₆, R₇ and R₈ represent a hydrogen atom, a methyl radical or an ethyl radical, p and q, which are identical or different, represent a number between 0 and 10, it being understood that the sum p+q is greater than zero. Use as chain extender in polyurethane elastomer formulations and/or as monomers in the preparation of saturated or unsaturated polyesters, of polycarbonates or of epoxy resins.

The invention comes within the field of the preparation of elastomers.

The preparation of elastomeric polymers often makes use of chain-extending compounds, the role of which is to improve certain physical properties of the final polymer, such as its hardness, its resistance to heat or its resistance to hydrolysis.

The most widely used chain extenders in the preparation of polyurethane elastomers are 1,4-butanediol or BDO:

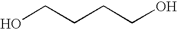

1,4-bis[(2-hydroxyethyl)oxy]benzene or HQEE:

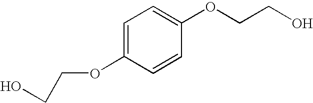

or diethoxylated resorcinol or HER:

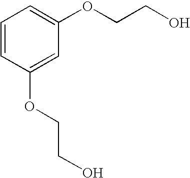

In the context of its research into polyalkoxylated compounds, the Applicant Company has developed a novel chain extender which improves the physical properties of polyurethane polymers.

For this reason, a subject-matter of the invention is a composition, characterized in that it comprises

from 0.5% to 100% by weight of a compound of formula (I):

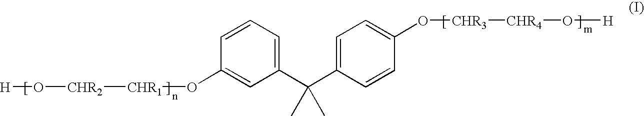

in which R₁, R₂, R₃ and R₄, which are identical or different, represent, independently of one another, a hydrogen atom, a methyl radical or an ethyl radical,

n and m, which are identical or different, represent, independently of one another, a number between 0 and 10, it being understood that the sum n+m is greater than zero,

and

from 0% to 99.5% by weight of a compound of formula (II):

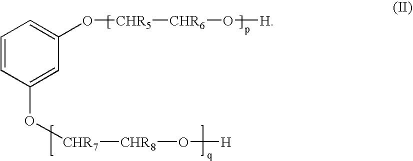

in which R₅, R₆, R₇ and R₈, which are identical or different, represent, independently of one another, a hydrogen atom, a methyl radical or an ethyl radical, p and q, which are identical or different, represent, independently of one another, a number between 0 and 10, it being understood that the sum p+q is greater than zero.

In the formulae (I) and (II) as defined above, the radicals:
—O—CHR₁—CHR₂—, —CHR₃—CHR₄—O—, —CHR₅—CHR₆—O— and —CHR₇—CHR₈—O—,
   more particularly represent, independently of one another, one of the following divalent radicals:
—O—CH₂—CH₂—, —CH₂—CH(CH₃)—O—, —CH(CH₃)—CH₂—O—, —CH (C₂H₅)—CH₂—O— or —CH₂—CH(C₂H₅)—O—.

Within each of the groups —[O—CHR₁—CHR₂]ₙ—, —[CHR₃—CHR₄—O]ₘ—, —[CHR₅—CHR₆—O]ₚ— or —[CHR₇—CHR₈—O]_{q}—, the —O—CH₂—CH₂—, —CH₂—CH(CH₃)—O—, —CH(CH₃)—CH₂—O—, —CH(C₂H₅)—CH₂—O— or —CH₂—CH(C₂H₅)—O— radicals are distributed in block or random fashion.

According to a specific aspect, a subject-matter of the invention is a composition as defined above for which, in the formula (I), R₁, R₂, R₃ and R₄ each represent a hydrogen atom.

According to another specific aspect, a subject-matter of the invention is a composition as defined above for which, in the formula (II) , R₅, R₆, R₇ and R₈ each represent a hydrogen atom.

According to yet another specific aspect, a subject-matter of the invention is a composition as defined above comprising from 10% by weight to 60% by weight and preferably from 15% by weight to 55% by weight of compound of formula (I) and from 40% by weight to 90% by weight and preferably from 45% by weight to 85% by weight of compound of formula (II).

A very particular subject-matter of the invention is a composition as defined above in which the compound of formula (I) is diethoxylated bisphenol A of formula (Ia): 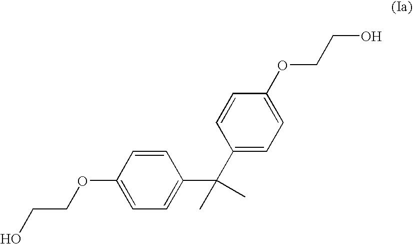
and in which the compound of formula (II) is diethoxylated resorcinol of formula (IIa): 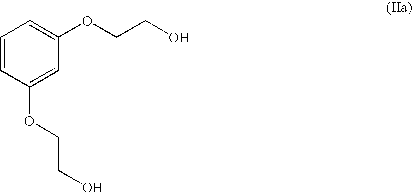
and a preferred subject-matter of the invention is a composition comprising from 30% by weight to 50% by weight of compound of formula (Ia) and from 50% by weight to 70% by weight of compound of formula (IIa).

According to another aspect, a subject-matter of the invention is also the use of the composition as defined above as chain extender in a polyurethane elastomer formulation and a process for the preparation of a polyurethane elastomer formulation starting from isocyanate prepolymer and from an effective amount of chain extender, characterized in that the said chain extender is the composition as defined above.

According to a final aspect, a subject-matter of the invention is the use of the composition as defined above as monomers in the preparation of saturated or unsaturated polyesters, of polycarbonates or of epoxy resins.

The following account illustrates the invention without, however, limiting it.

A mixture of 52% by weight of diethoxylated resorcinol and 48% by weight of diethoxylated bisphenol A, known as composition E, is prepared.

Two polyurethane elastomer compositions are subsequently prepared according to an experimental method known to a person skilled in the art, the parameters of which are recorded in the following Table 1, starting from Vibrathane™ B625, which is an isocyanate prepolymer having a percentage of isocyanate (—N—C═O) functional group of between 6.2 and 6.9, and from a chain extender, 1,4-butanediol for formulation A according to the state of the art or composition E for formulation I according to the invention.

TABLE 1

| | Formulation | |
|---|---|---|
| | Formulation A | Formulation I |
| | (comparative base) | (invention) |
| Vibrathane ™ B625 | 100 g | 100 |
| (% NCO: 6029) | | |
| 1,4-Butanediol | 6.41 g | 0 |
| Composition E | 0 | 7.39 g |
| Byk ™ A 530 | 0.5 g | 0.5 g |
| (antifoam agent) | | |
| Pot life | 6 minutes | 21 minutes |
| Process parameters | | |
| Temperature of the | 85° C. | 85° C. |
| prepolymer | | |
| Temperature of the extender | 85° C. | 85° C. |
| Curing temperature | 120° C. | 120° C. |
| Stirring time | 30 minutes | 30 minutes |
| Curing time | 4 hours | 4 hours |
| Postcuring time | 16 hours | 16 hours |
| Maturing time | 6 days | 6 days |
| Appearance of the final | opaque | slight |
| formulation | | transparency |
| Glass transition | −69.7° C. | −55.7° C. |
| temperature | | |
| Melting point | 169.2° C. | 157° C. |

The mechanical properties of both formulation A and formulation I are evaluated before ageing, after ageing in a dry oven and after ageing in a humid oven.

The results are recorded in the following Tables 2, 3 and 4.

TABLE 2
Mechanical properties before ageing

| | Formulation A | Formulation I |
|---|---|---|
| | (comparative) | (invention) |
| Hardness (according to Standard | 84 | 87 |
| ISO 868) | | |
| Tensile properties (according to | | |
| Standard ISO 37) | | |
| Stress at 100% | 6.15 MPa | 7.34 MPa |
| Stress at 200% | 9.16 MPa | 10.11 MPa |
| Stress at 300% | 12.78 MPa | 12.93 MPa |
| Tensile strength | 20.01 MPa | 18.15 MPa |
| Elongation at break | 450% | 485% |
| Young's modulus | 16.88 MPa | 22.15 MPa |
| Tear strength (according to | 44.43 kN/m | 69.63 kN/m |
| Standard ISO 34) | | |
| Abrasion resistance (according | 0.05% | 0.17% |
| to Standard ISO 9352) | | |
| Density (according to Standard | 1.03 | 1.04 |
| ISO 1183) | | |
| Rebound (according to Standard | 69 | 60 |
| ISO 4662) | | |

TABLE 3
Mechanical properties after ageing in a dry oven

| | |
|---|---|
| Formulation A | Formulation I |
| (comparative) | (invention) |

Ageing for 400 hours at 110° C.

| | | |
|---|---|---|
| Appearance of the elastomer | dark brown, | yellow, |
| | opaque | slightly |
| | | transparent |
| Hardness (according to Standard | 78 | 84 |
| ISO 868) | | |
| Tensile properties (according to | | |
| Standard ISO 37) | | |
| Stress at 100% | 4.06 MPa | 5.80 MPa |
| Stress at 200% | 5.63 MPa | 7.15 MPa |
| Tensile strength | 6.55 MPa | 8.35 MPa |
| Elongation at break | 270% | 290% |
| Young's modulus | 11.32 MPa | 20.74 MPa |

Ageing for 800 hours at 110° C.

| | | |
|---|---|---|
| Appearance of the elastomer | very dark brown, | brown, |
| | opaque | slightly |
| | | transparent |
| Hardness (according to Standard | 74 | 84 |
| ISO 868) | | |
| Tensile properties (according to | | |
| Standard ISO 37) | | |
| Stress at 100% | 3.45 MPa | 5.44 MPa |
| Stress at 200% | 4.86 MPa | 6.24 MPa |
| Tensile strength | 5.53 MPa | 6.27 MPa |
| Elongation at break | 230% | 202% |
| Young's modulus | 9.86 MPa | 19.68 MPa |
| Tear strength (according to | 22.45 kN/m | 41.63 kN/m |
| Standard ISO 34) | | |

TABLE 4
Mechanical properties after ageing in a humid oven

| | |
|---|---|
| Formulation A | Formulation I |
| (comparative) | (invention) |

Ageing for 400 hours at 70° C.; humidity: 98%

| | | |
|---|---|---|
| Appearance of the elastomer | yellow | slightly |
| | | yellow |
| Hardness (according to Standard | 81 | 87 |
| ISO 868) | | |
| Tensile properties (according to | | |
| Standard ISO 37) | | |
| Stress at 100% | 5.13 MPa | 6.49 MPa |
| Stress at 200% | 7.83 MPa | 9.18 MPa |
| Stress at 300% | 10.87 MPa | 11.70 MPa |
| Tensile strength | 17.08 MPa | 16.79 MPa |
| Elongation at break | 440% | 500% |
| Young's modulus | 13.57 MPa | 19.09 MPa |

Ageing for 800 hours at 70° C.; humidity: 98%

| | | |
|---|---|---|
| Appearance of the elastomer | yellow | slightly |
| | | yellow |
| Hardness (according to Standard | 80 | 87 |
| ISO 868) | | |
| Tensile properties (according to | | |
| Standard ISO 37) | | |
| Stress at 100% | 5.07 MPa | 5.44 MPa |
| Stress at 200% | 7.56 MPa | 6.24 MPa |
| Stress at 300% | 10.77 MPa | 6.27 MPa |
| Tensile strength | 17.50 MPa | 16.84 MPa |
| Elongation at break | 440% | 500% |
| Young's modulus | 13.38 MPa | 41.63 MPa |
| Tear strength (according to | 37.68 kN/m | 62.50 kN/m |
| Standard ISO 34) | | |

These results clearly reveal the advantage that there is in using composition E according to the invention as chain extender in comparison with 1,4-butanediol, the product most widely used for this purpose.

1-9. (canceled)

10. A composition comprising:
a) from about 0.5% to about 100% by weight of the compound with formula (I) 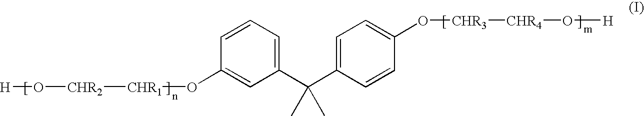
wherein
1) R₁, R₂, R₃ and R₄ each comprise at least one member selected from the group consisting of:
i) a hydrogen atom;
ii) a methyl radical; and
iii) an ethyl radical;
2) n and m each represent a number between about 0 and about 10 and wherein the sum of (n+m) is greater than zero; and
b) from about 0% to about 99.5% by weight of the compound with formula (II): 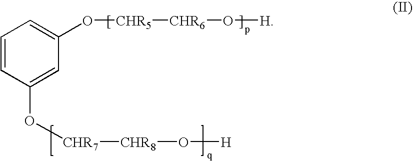
wherein:
1) R₅, R₆, R₇ and R₈ each comprise at least one member selected from the group consisting of:
i) a hydrogen atom;
ii) a methyl radical; and
iii) an ethyl radical; and
2) p and q each represent a number between about 0 and about 10 and wherein the sum of (p+q) is greater than zero.

11. The composition of claim 10, wherein R₁, R₂, R₃ and R₄ are each a hydrogen atom.

12. The composition of claim 10, wherein R₅, P₆, R₇ and R₈ are each a hydrogen atom.

13. The composition of claim 10, further comprising:
a) from about 10% by weight to about 60% by weight of said formula (I) compound; and
b) from about 40% by weight to about 90% by weight of said formula (II) compound.

14. The composition of claim 13, further comprising:
a) from about 15% by weight to about 55% by weight of said formula (I) compound; and
b) from about 45% by weight to about 85% by weight of said formula (II) compound.

15. The composition of claim 10, wherein:
a) said formula (I) compound is diethoxylated bisphenol A with the formula (Ia); and 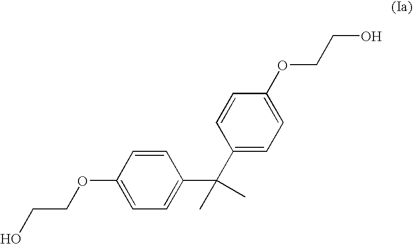
b) said formula (II) compound is diethoxylated resorcinol with the formula (IIa).

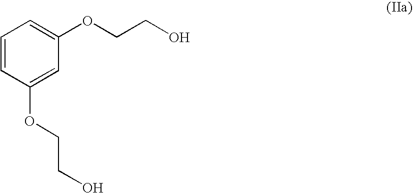

16. The composition of claim 15, further comprising:
a) from about 30% by weight to about 50% by weight of said formula (la) compound; and
b) from about 50% by weight to about 70% by weight of said formula (IIa) compund.

17. A method of extending a chain in a polyurethane elastomer formulation comprising:
a) providing said polyurethane elastomer pre-cursor; and
b) treating said pre-cursor with a composition, said composition comprising:
1) from about 0.5% to about 100% by weight of the compound formula (I): 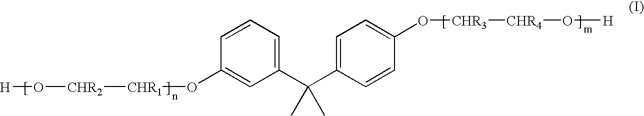
wherein:
i) R₁, R₂, R₃ and R₄ each comprise at least one member selected from the group consisting of:
aa) a hydrogen atom;
bb) a methyl radical; and
cc) an ethyl radical; and
ii) n and m each represent a number between about 0 and about 10 and wherein the sum of (n+m) is greater than zero; and
2) from about 0% to about 99.5% by weight of the compound of formula (II): 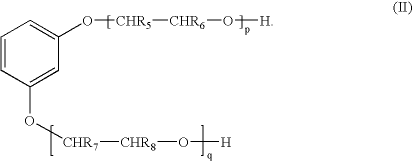
wherein:
i) R₅, R₆, R₇ and R₈ each comprise at least one member selected from the group consisting of:
aa) a hydrogen atom;
bb) a methyl radical; and
cc) an ethyl radical; and
ii) p and q each represent a number between about 0 and about 10 and wherein the sum of (p+q) is greater than zero.

18. A method of preparing a polyurethane elastomer formulation comprising reacting an isocyante prepolymer with a chain extender, said chain extender comprising:
a) from about 0.5% to about 100% by weight of the compound with formula (I): 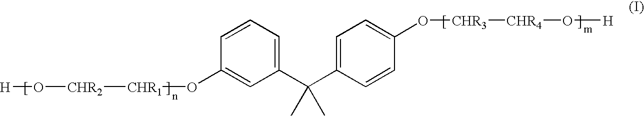
wherein:
1) R₁, R₂, R₃ and R₄ each comprise at least one member selected from the group consisting of:
i) a hydrogen atom;
ii) a methyl radical; and
iii) an ethyl radical; and
2) n and m each represent a number between about 0 and about 10 and wherein the sum of (n+m) is greater than zero; and
b) from about 0% to about 99.5% by weight of the compound of formula (II): 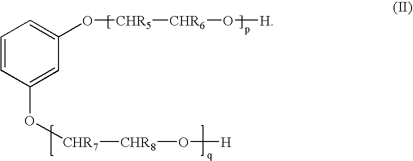
wherein:
1) R₅, R₆, R₇ and R₈ each comprise at least one member selected from the group consisting of:
i) a hydrogen atom;
ii) a methyl radical; and
iii) an ethyl radical; and
2) p and q each represent a number between about 0 and about 10 and wherein the sum of (p+q) is greater than zero.

19. A method of utilizing a composition in the preparation of a compound wherein:
a) said compound comprises at least member selected from the group consisting of:
1) saturated polyesters;
2) unsaturated polyesters;
3) polycarbonates; and
4) epoxy resins; and
b) said composition comprises monomers, said monomers comprising:
1) from about 0.5% to about 100% by weight of the compound with formula (I): 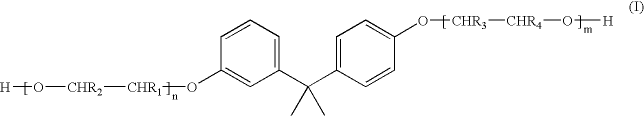
wherein:
i) R₁, R₂, R₃ and R₄ each comprise at least one member selected from the group consisting of:
aa) a hydrogen atom;
bb) a methyl radical; and
cc) an ethyl radical; and
ii) n and m each represent a number between about 0 and about 10 and wherein the sum of (n+m) is greater than zero; and
2) from about 0% to about 99.5% by weight of the compound with formula (II): 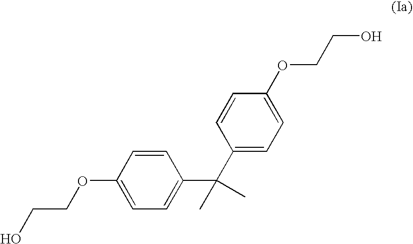
wherein:
i) R₅, R₆, R₇ and R₈ each comprise at least one member selected from the group consisting of:
aa) a hydrogen atom;
bb) a methyl radical; and
cc) an ethyl radical; and
ii) p and q each represent a number between 0 and 10 and wherein the sum of (p+q) is greater than zero.
